(19) United States
(12) Patent Application Publication
(10) Pub. No.: US 2019/0086006 A1
(43) Pub. Date: Mar. 21, 2019

(54) SEISMIC GROOVELESS COUPLING

(71) Applicant: Sang Keon NAM, Gyeonggi-do (KR)

(72) Inventor: SANG KEON NAM, Paju-si (KR)

(21) Appl. No.: 15/560,169

(22) PCT Filed: Nov. 14, 2016
(86) PCT No.: PCT/KR2016/013079

§ 371 Date: Sep. 21, 2017

(30) Foreign Application Priority Data
Jul. 14, 2016 (KR) 10-2016-0089054
Aug. 29, 2016 (KR) 10-2016-0110364

(51) Int. Cl. F16L 17/06; F16L 21/06

(52) U.S. Cl. CPC F16L 17/06; F16L 21/06

(57) ABSTRACT

A seismic grooveless coupling is provided, which allows pipes to be connected by only pushing the pipes that do not have grooves on both sides thereof and fastening a bolt with a nut while the upper and lower coupling segments are assembled. The seismic grooveless coupling disclosed includes a packing made of an elastic material, wherein pipes transferring fluid are inserted into the packing from left and right sides, upper and lower coupling segments configured to restrict an axial movements of the pipes at both sides while surrounding the packing to be accommodated from upper and lower sides and getting closer to each other, and a fastening unit including a bolt and a nut configured to fasten the upper and lower coupling segments each other.

### CROSS-REFERENCE TO RELATED APPLICATIONS

This application claims priority to PCT Application No. PCT/KR2016/013079 having a filing date of Nov. 14, 2016, based off of Korean Patent Application No. 10-2016-0110364 having a filing date of Aug. 29, 2016 and Korean Patent Application No. 10-2016-0089054 having a filing date of Jul. 14, 2016, the entire contents of all which are hereby incorporated by reference.

### FIELD OF TECHNOLOGY

The following relates to a coupling and, more specifically, to a seismic grooveless coupling which allows fluid transport pipes or tubes to be connected without forming a groove at an end thereof when the fluid transport pipes or tubes are connected.

### BACKGROUND

Generally, it has been institutionalized that many buildings have a sprinkler system for fire extinguishing. Also, it becomes more important to have the system for fire extinguishing in a residence.

A regulation of a fire extinguishing tube system, such as a use of a fluid transport metal pipe, is recently revised such that tubes cannot be welded, and thus the tubes should be mechanically connected. As known in Korean Patent Registration No. 10-1332558 (Title of the Invention: System and method of assembly of CPVC fire sprinkler system employing mechanical couplings and supports), pipes have circle-shaped outer grooves separated from ends of the pipes in an axial direction, each of the pipes has a circle-shaped sealing surface part formed between the circle-shaped outer groove and the end, and the pipes are connected with each other by the coupling.

In this case, the coupling includes a circle-shaped elastic sealing member having inner sealing surfaces formed on both sides thereof to be coupled with the circle-shaped sealing surface parts of the pipes in a sealing manner, and coupling segments mounted in a circle-shaped outer groove of the pipe while surrounding the sealing member from upper and lower portions thereof, and a bolt and a nut pressing the coupling segments each other.

Therefore, when the bolt and the nut are fastened to each other, the pipes are sealed by a sealing member so that fluid is not leaked while the upper and lower coupling segments are attached to each other, and both ends protruding from inner circumferential surfaces of the upper and lower coupling segments are mounted in the circle-shaped outer grooves formed in the pipes to be fastened so that the pipes are not separated.

However, forming the circle-shaped outer groove on the pipe has many problems in which preparation of a work space and a process of forming the circle-shaped outer groove after installation of a machine are complicated and difficult, a flow of fluid is not good, and vibration is generated because a predetermined amount of the circle-shaped outer groove protrudes from an inner diameter when the circle-shaped outer groove is formed such that the flow of fluid is interrupted.

Also, the coupling has a fluid leakage when the pipe expands and contracts. When the coupling segments are assembled to the pipes, sealing members are inserted into the pipes, and the bolt and the nut are fastened while the coupling segments are attached from an upper portion and a lower portion of the pipes. Due to parts protruding from inner sides of the coupling segments and inserted into the circle-shaped outer grooves of the pipes, the bolt and the nut are not easily tightened, and thus there are problems in which an assembly work is very difficult and a lot of work time are required.

### SUMMARY

An aspect relates to a seismic grooveless coupling which allows pipes to be connected while being changed to surround the pipes by incised grooves of upper and lower coupling segments by only pushing the pipes that do not have grooves on both sides thereof and fastening a bolt with a nut while the upper and lower coupling segments are assembled.

Embodiments of the present invention are directed to providing a seismic grooveless coupling which includes a gripping part which is formed in upper and lower coupling segments in a fabricating type to be changed to a general movement type coupling and a high pressure movement type coupling and to be applied to a needed configuration depending on an environment of a piping work.

Embodiments of the present invention are directed to providing a seismic grooveless coupling which includes a plurality of fluid flow guiding grooves formed in a pipe stopper of a packing at regular angles and communicating with a packing-first inner surface to prevent contamination when a fluid in the packing-first inner surface flows with a fluid in a flow path of the pipe.

Embodiments of the present invention are directed to providing a seismic grooveless coupling which includes incised groove mounting protrusion parts which are reinforcing members formed on both sides of a packing and mounted in incised grooves formed in upper and lower coupling segments to prevent a side of the packing from easily bursting by a pressure.

Embodiments of the present invention are directed to providing a seismic grooveless coupling which includes spacing elastic members, each of which is a rubber tube with a predetermined length and is disposed between both ends of upper and lower coupling segments fastened by a fastening unit to allow pipes to be easily inserted.

Embodiments of the present invention are directed to providing a seismic grooveless coupling which includes a plurality of sawtooth-shaped sealing lips provided in pipe sealing units on both ends of a packing attached to outer circumferential surfaces of pipes to easily perform sealing when the pipes expand or contract.

One aspect of the present invention provides a seismic grooveless coupling which includes a packing made of an elastic material and into which pipes transferring fluid are inserted from left and right sides in a central direction thereof, upper and lower coupling segments including a packing accommodating groove formed to surround and accommodate the packing from upper and lower sides, an outer diameter of a gripping part having a diameter less than that of a packing accommodating-outer circumferential surface with the packing accommodating groove and extending from both sides of the packing accommodating-outer circumferential surface, and gripping parts formed at both ends of an inner circumferential surface with the packing accommodating groove in a sawtooth shape to restrict the axial movements of the pipes while getting closer to each other, and a fastening unit configured to fasten the upper and lower segments each other, wherein the upper and lower coupling segments include incised grooves which are an inner circumferential surface in which the packing accommodating groove is formed, are formed with a predetermined width in an axial direction at regular angles in a radial direction of center direction-both ends, and have a slot shape to be formed from the outer diameter of the gripping part to the inner diameter of the packing accommodating groove.

The gripping parts may include a first groove which is an inner circumferential surface-both end configured by assembling the upper and lower coupling segments, is formed in an axial center part of the incised groove in a circle shape, and has a fixing ring adhesive surface having a spherical inner circumferential surface, and a gripping fixing ring inserted into the first groove in a width less than a width of the first groove to come into contact with the spherical surface from the fixing ring adhesive surface, and having a C shape made by cutting one side thereof, wherein the gripping fixing ring may have an inner circumferential surface in a sawtooth shape.

The packing may include a pipe stopper formed at an axial center of a packing-first inner surface to protrude toward an axial center to prevent the pipes from being attached to each other and formed in a circular shape, and pipe sealing parts formed at both ends extending from the packing-first inner surface in an axial direction and having a C-shaped cross-section to be attached to the outer circumferential surfaces of ends of the pipes inserted into the both ends, wherein an inner circumferential surface of the pipe stopper may have a plurality of fluid flow guiding grooves formed at regular angles and communicating with a space between the pipe sealing part and the packing-first inner surface so that a fluid introduced into the space flows to the pipes.

The packing may include incised groove-mounting protrusions which are reinforcing members to prevent the packing from bursting toward the incised grooves by a pressure while being inserted into the incised grooves and formed at both surfaces thereof.

The fastening unit may include a bolt and a nut and further include a spacing elastic member which is a rubber tube with a predetermined length and formed between both ends perpendicular to an axial direction of the upper and lower coupling segments fastened by the fastening member, and the bolt may be inserted into an axial center of the spacing elastic member.

The pipe sealing parts on both ends of the packing may include a plurality of sawtooth-shaped sealing lips attached to the outer circumferential surfaces of the ends of the pipes.

The gripping parts may include second grooves which are both ends of the inner circumferential surface formed by assembling the upper and lower coupling segments and are formed in a circular shape at an axial center of the incised grooves, a C-shaped movable ring having one cut side to be inserted into the second grooves, having an outer circumferential surface formed to be parallel to an axial direction to move in an axial direction of the second groove, and having a third groove formed on the inner circumferential surface thereof, and a gripping fixing ring having a sawtooth shape at an inner circumferential surface thereof and having one cut side with a C-shaped cross-section to be inserted into the third groove. An inner circumferential surface of the third groove of the movable ring may be a curved surface, and an outer circumferential surface of the gripping fixing ring may be also a curved surface corresponding to the inner circumferential surface of the third groove.

The coupling may further include a circle-shaped press maintaining plate disposed in a packing mounting groove in which the packing of the upper and lower coupling segments is mounted, and the press maintaining plate may be installed between both surfaces of the packing and the gripping parts.

Another aspect of the present invention provides a seismic grooveless coupling which includes a packing made of an elastic material, having pipes transferring a fluid and inserted thereto from left and right sides in a central axis direction, and including a pipe stopper formed at an axial center of the packing-first inner surface to protrude toward an axial center to prevent the pipes from being attached to each other and formed in a circular shape, and pipe sealing parts provided at both ends axially extending from the packing-first inner surface and having a C-shaped cross-section to be attached to outer circumferential surfaces of ends of the pipes inserted into the both ends, upper and lower coupling segments including a packing accommodating groove formed to surround and accommodate the packing from upper and lower sides, outer diameters of gripping parts having a diameter smaller than a diameter of a packing accommodating outer circumferential surface in which the packing accommodating groove is formed and extending from both sides of the packing accommodating outer circumferential surface, and gripping parts formed at both ends of an inner circumferential surface in which the packing accommodating groove is formed and having a sawtooth shape to restrict axial movements of the pipes while getting closer to each other, and a fastening unit configured to fasten the upper and lower coupling segments each other, wherein the pipe stopper includes a plurality of fluid flow guiding grooves formed at regular angles to communicate with a space between the packing-first inner surface and the pipe sealing part so that a fluid flowing to the pipe is introduced between the packing-first inner surface and the pipe sealing part and then flows through the pipes again.

The upper and lower coupling segments may include incised grooves which are an inner circumferential surface in which the packing accommodating groove is formed, are formed with a predetermined width in an axial direction at regular angles in a radial direction of center direction-both ends, and have a slot shape to be formed from the outer diameter of the gripping part to the inner diameter of the packing accommodating groove, and incised groove-mounting protrusions which are reinforcing members to prevent the packing from bursting toward the incised grooves by a pressure while being inserted into the incised grooves and are formed at both surfaces the packing.

The pipe sealing part of the packing may include a plurality of sawtooth sealing lips attached to outer circumferential surfaces of ends of the pipes.

According to the seismic grooveless coupling according to embodiments of the present invention described herein, pipes can be connected while the coupling is changed to surround the pipes by incised grooves of upper and lower coupling segments by only pushing the pipes that do not have grooves on both sides thereof and fastening a bolt with a nut while the upper and lower coupling segments are assembled. Accordingly, a work place and a machine for forming a circular outer groove on the pipe are not necessarily provided, and thus a work process is very simple. At the same time, when a circular outer groove is formed, the circular outer groove does not protrude even toward an inner diameter of the coupling, and a flow of a fluid is not interrupted, and thus the flow of a fluid can be facilitated and a vibration cannot be generated.

According to the seismic grooveless coupling according to embodiments of the present invention, a gripping part is formed in upper and lower coupling segments in a fabricating type to be changed to a general movement type coupling and a high pressure movement type coupling and to be applied to a needed configuration depending on an environment of a piping work.

According to the seismic grooveless coupling according to embodiments of the present invention, a plurality of fluid flow guiding grooves are formed in a pipe stopper of a packing at regular angles and communicate with a packing-first inner surface, and thus contamination can be prevented when a fluid in the packing-first inner surface flows with a fluid in a flow path of the pipe.

According to the seismic grooveless coupling according to embodiments of the present invention, incised groove mounting protrusion parts, which are reinforcing members formed on both sides of a packing, are mounted in incised grooves formed in upper and lower coupling segments, and thus a side of the packing can be prevented from easily bursting by a pressure.

According to the seismic grooveless coupling according to embodiments of the present invention, spacing elastic members, which are a rubber tube with a predetermined length, are disposed between both ends of the upper and lower coupling segments fastened by a fastening unit, and thus the pipes can be easily inserted.

According to the seismic grooveless coupling according to embodiments of the present invention, a plurality of sawtooth-shaped sealing lips are provided in pipe sealing units on both ends of a packing attached to an outer circumferential surface of the pipe, and thus sealing can be easily performed even though an end of the pipes escapes from any one or two of the sealing lips when the pipes expand or contract.

### BRIEF DESCRIPTION

Some of the embodiments will be described in detail, with reference to the following figures, wherein like designations denote like members, wherein:

FIG. 1 is a perspective view showing a seismic grooveless coupling according to a first embodiment of the present invention;

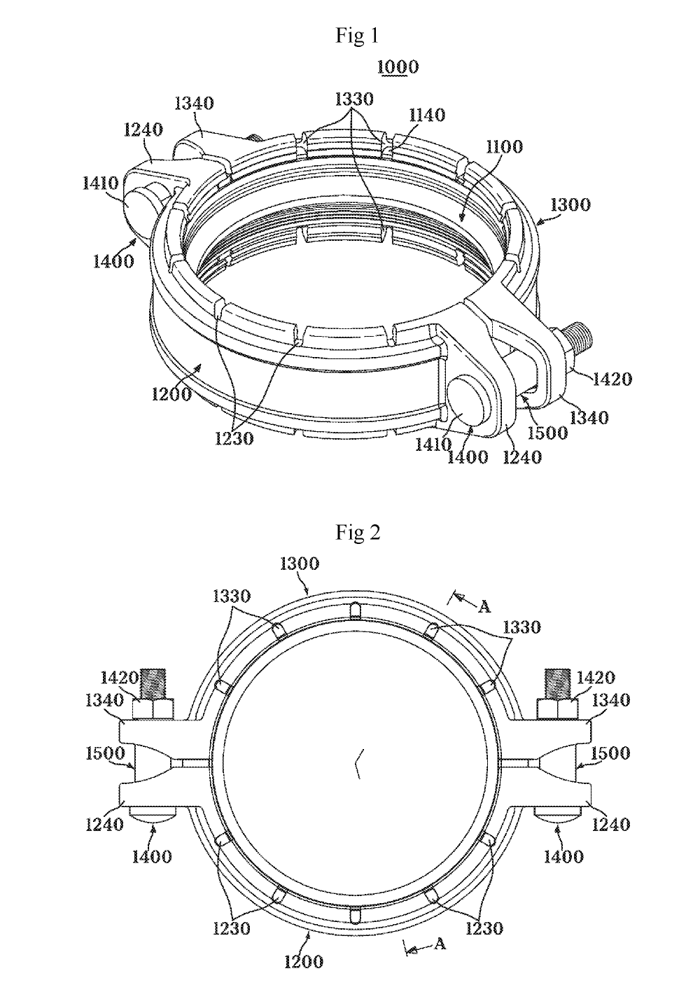

FIG. 2 is a plan view of FIG. 1;

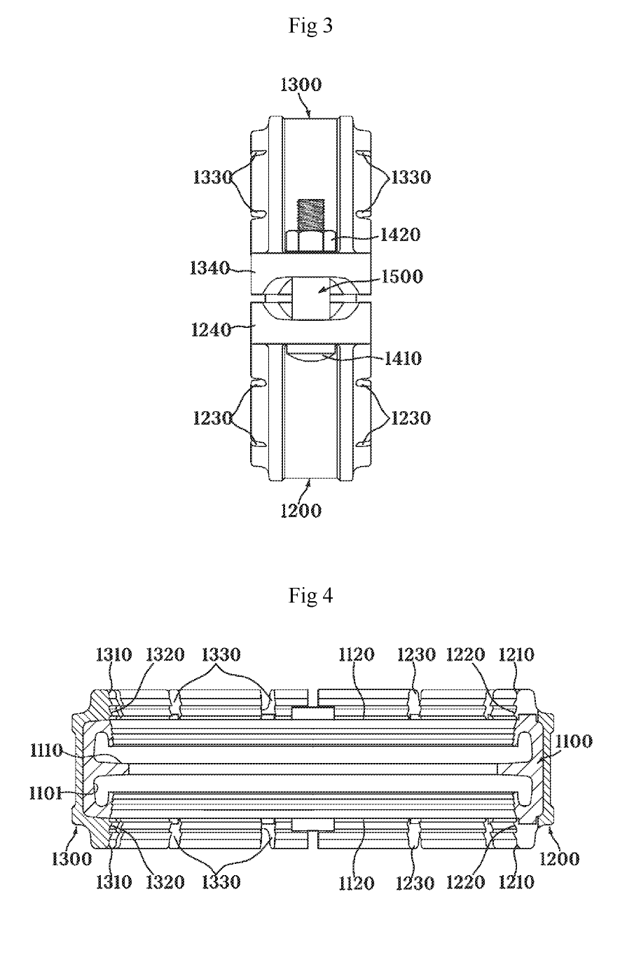

FIG. 3 is a right side view of FIG. 2;

FIG. 4 is a cross-sectional view taken along line A-A of FIG. 2;

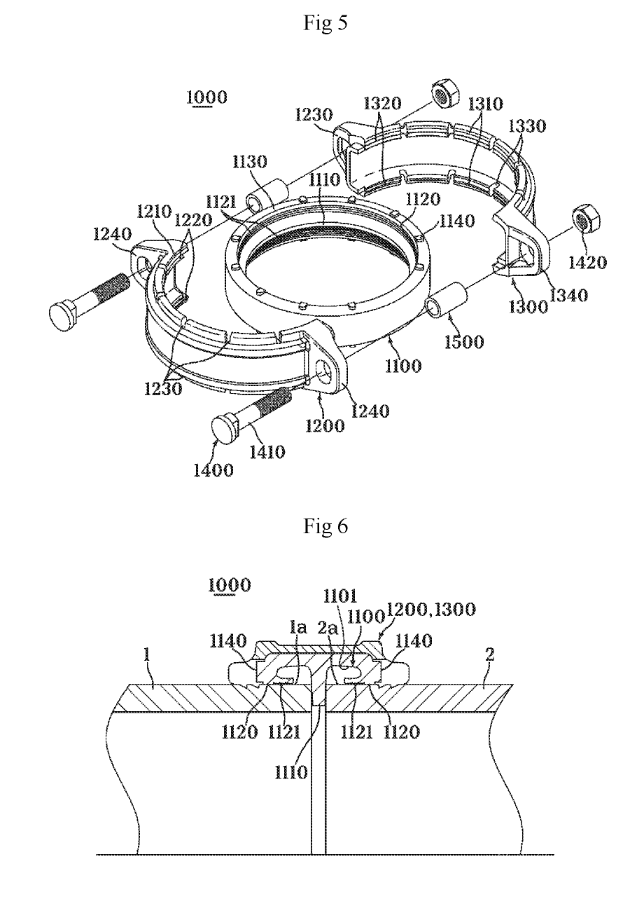

FIG. 5 is an exploded perspective view of FIG. 1;

FIG. 6 is a cross-sectional view showing a use state of FIG. 1;

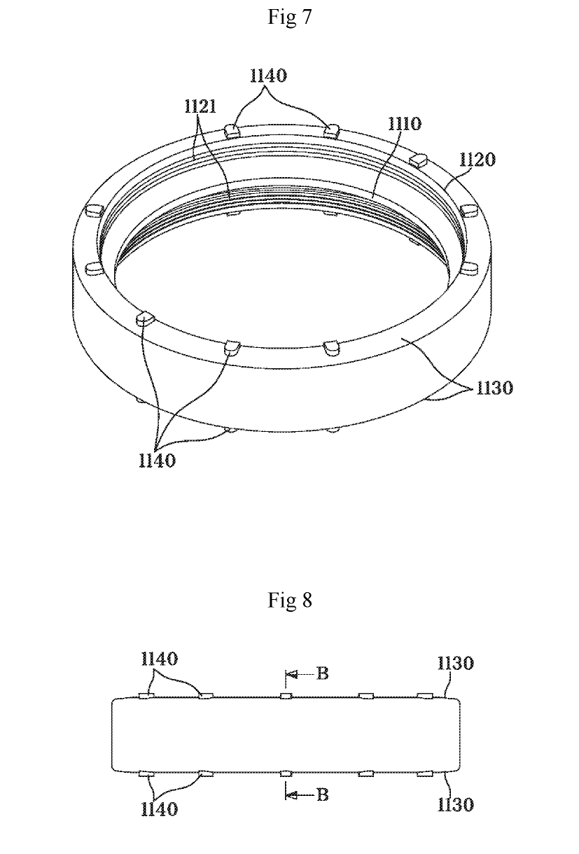

FIG. 7 is a perspective view showing a packing of FIG. 1;

FIG. 8 is a front view of FIG. 7;

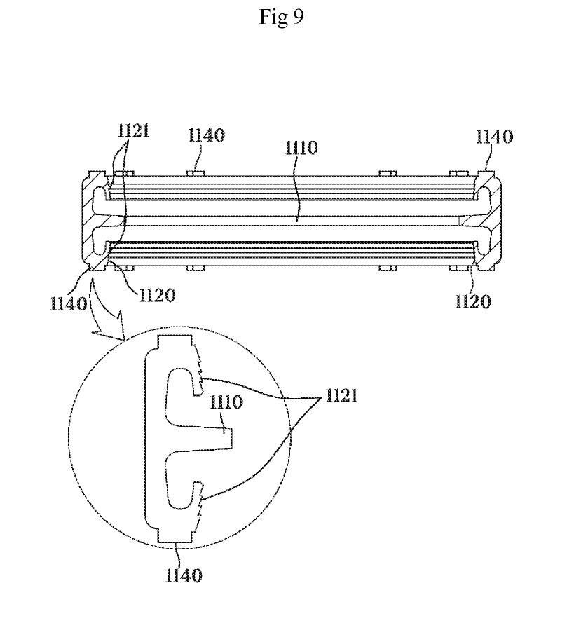

FIG. 9 is a cross-sectional view taken along line B-B of FIG. 8;

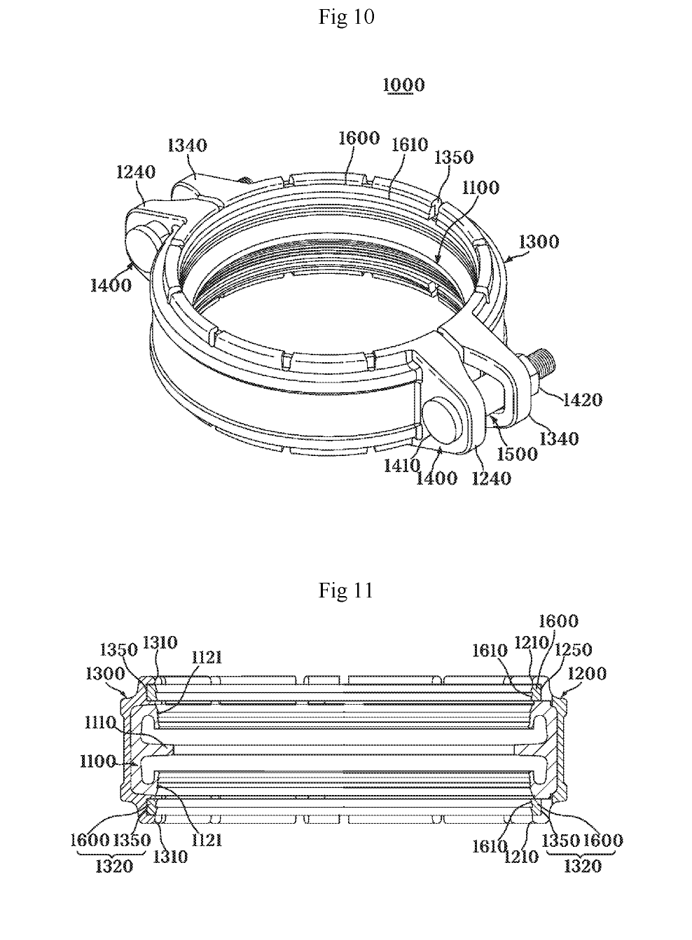

FIG. 10 is a perspective view showing a seismic grooveless coupling according to a second embodiment of the present invention;

FIG. 11 is a longitudinal cross sectional view of FIG. 10;

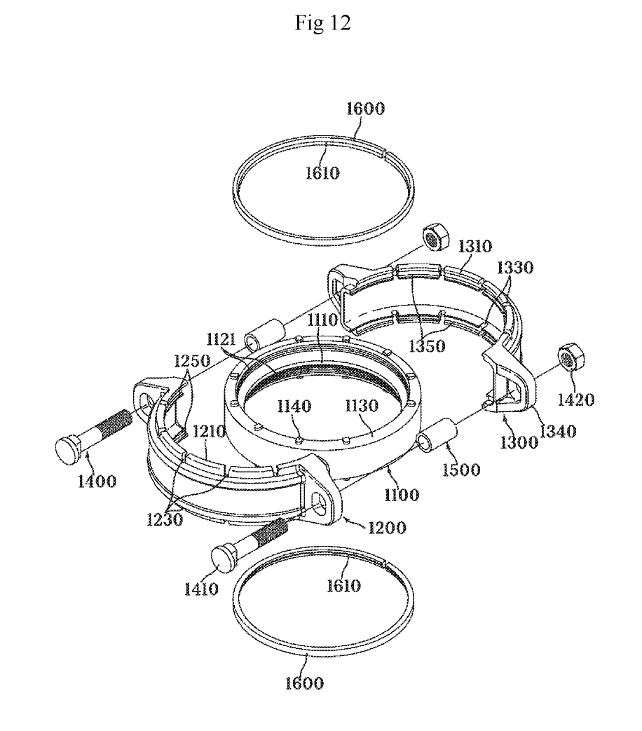

FIG. 12 is an exploded perspective view of FIG. 10;

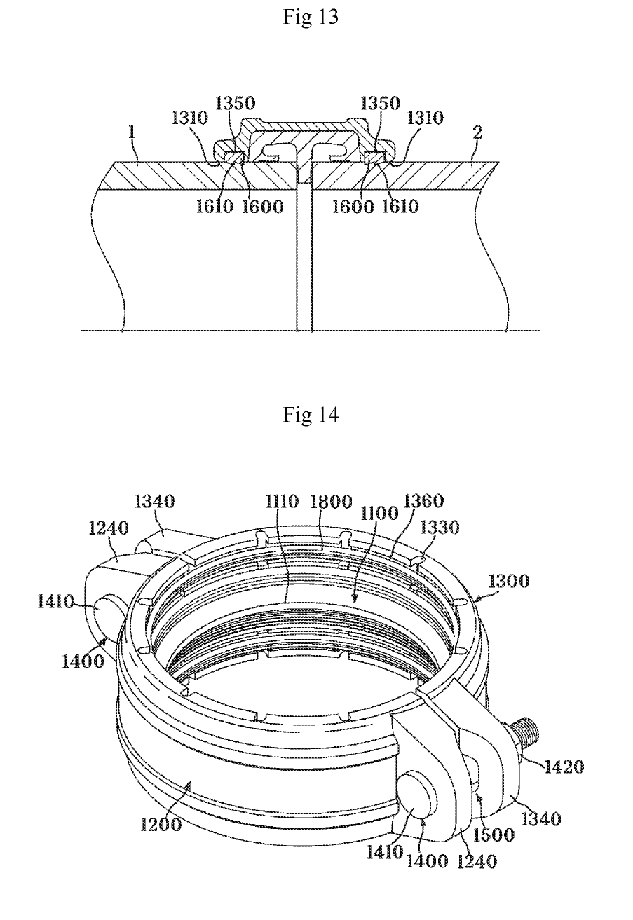

FIG. 13 is a cross-sectional view showing a use state of FIG. 10;

FIG. 14 is a perspective view showing a seismic grooveless coupling according to a third embodiment of the present invention;

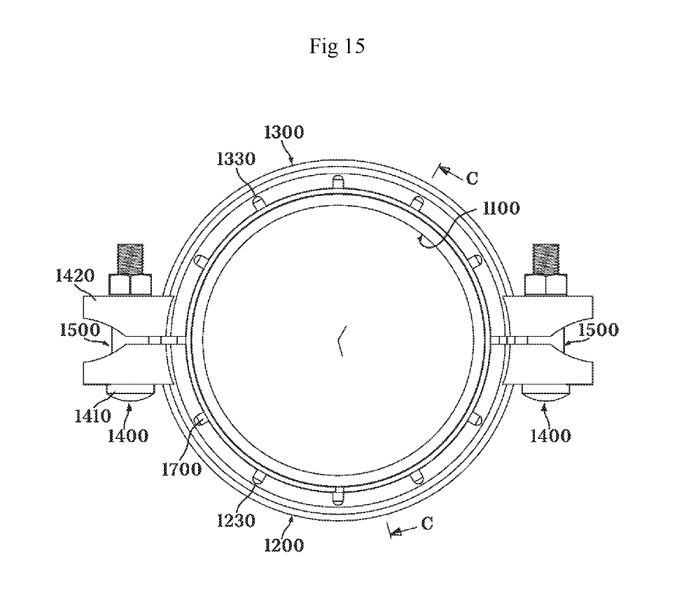

FIG. 15 is a plan view of FIG. 14;

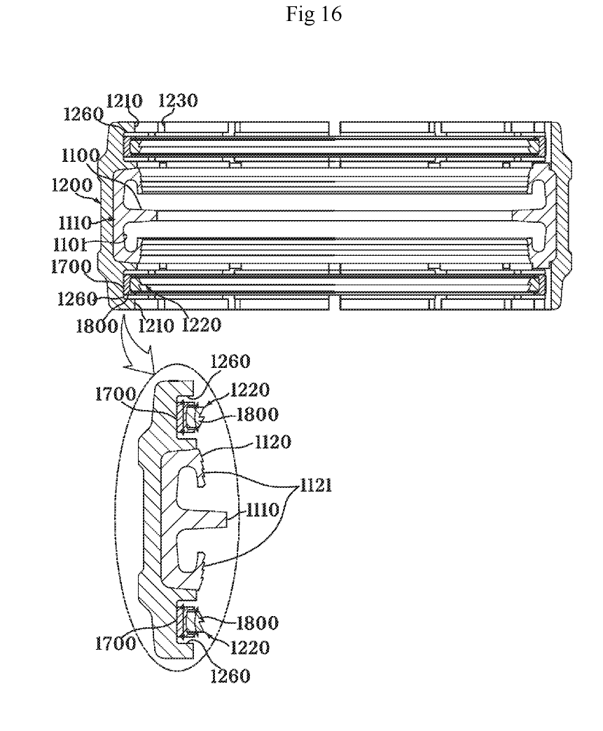

FIG. 16 is a cross-sectional view taken along line C-C of FIG. 15;

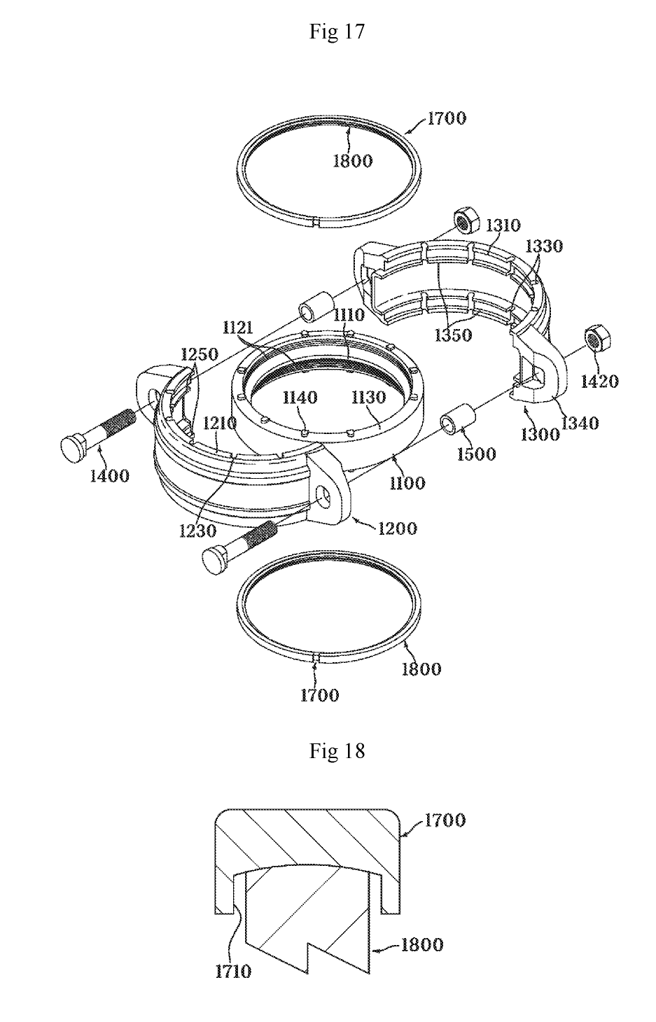

FIG. 17 is an exploded perspective view of FIG. 14;

FIG. 18 is an enlarged cross-sectional view for describing a movable ring of FIG. 17;

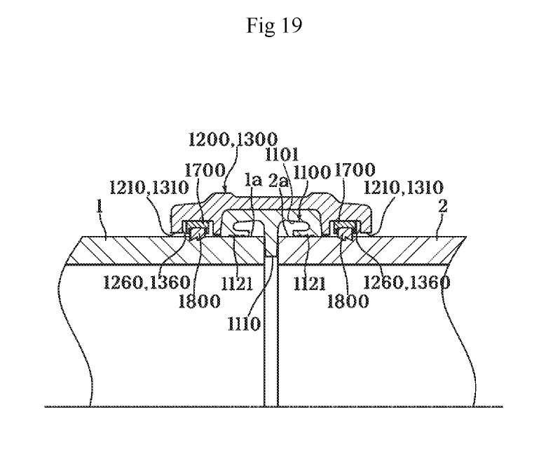

FIG. 19 is a cross-sectional view showing a use state of FIG. 14;

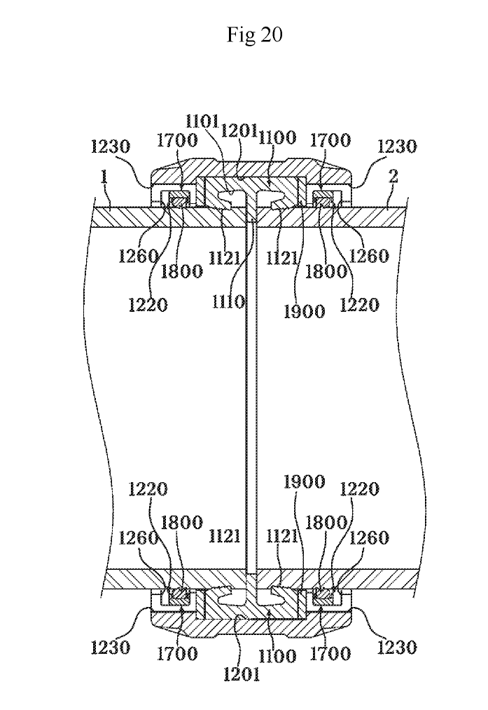

FIG. 20 is a cross-sectional view showing a use state of a grooveless coupling according to a fourth embodiment of the present invention;

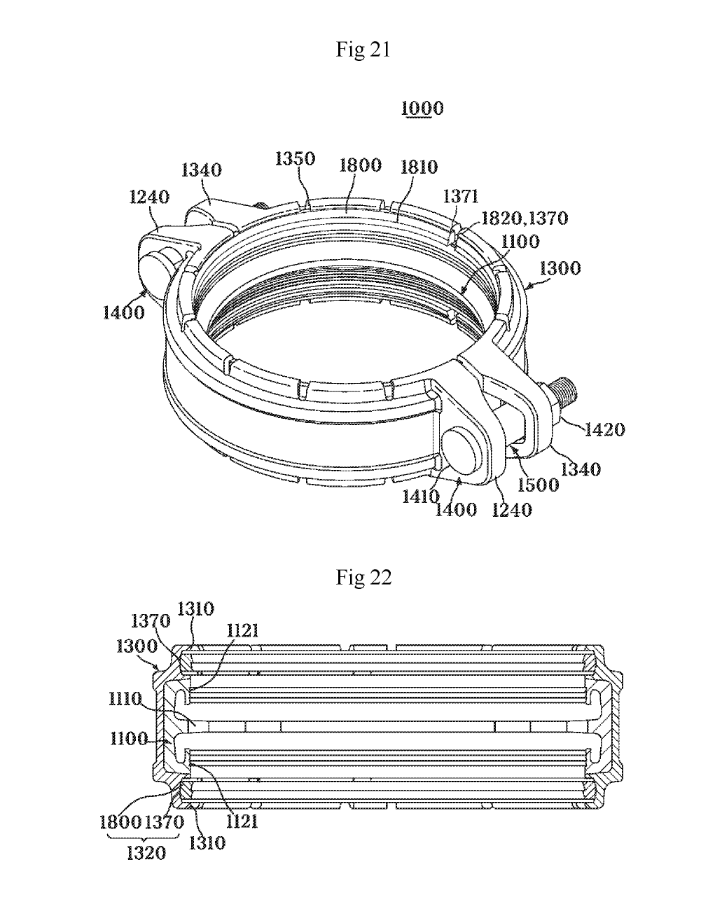

FIG. 21 is a perspective view of a grooveless coupling according to a fifth embodiment of the present invention;

FIG. 22 is a longitudinal cross sectional view of FIG. 21;

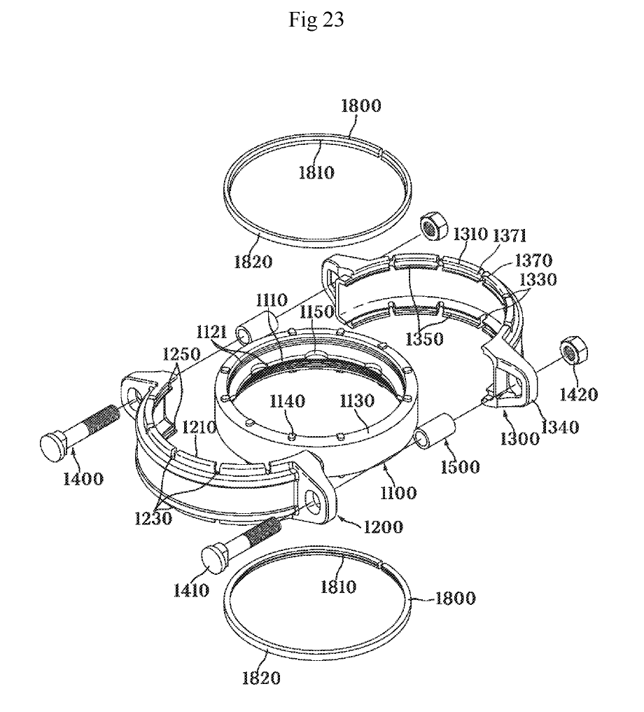

FIG. 23 is an exploded perspective view of FIG. 21;

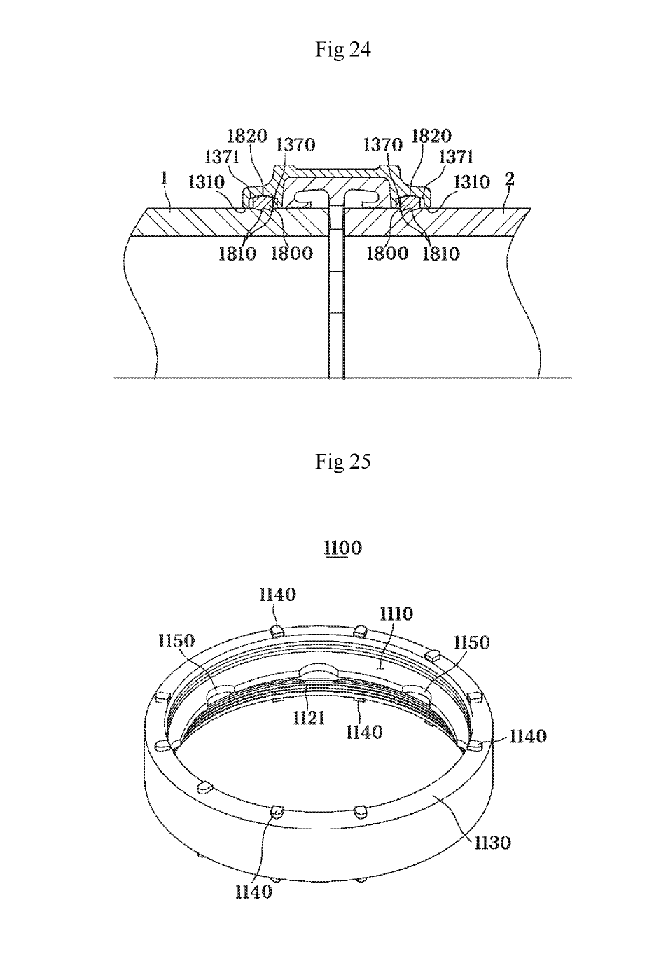

FIG. 24 is a cross-sectional view showing a use state of FIG. 21;

FIG. 25 is a perspective view for describing a packing of FIG. 21;

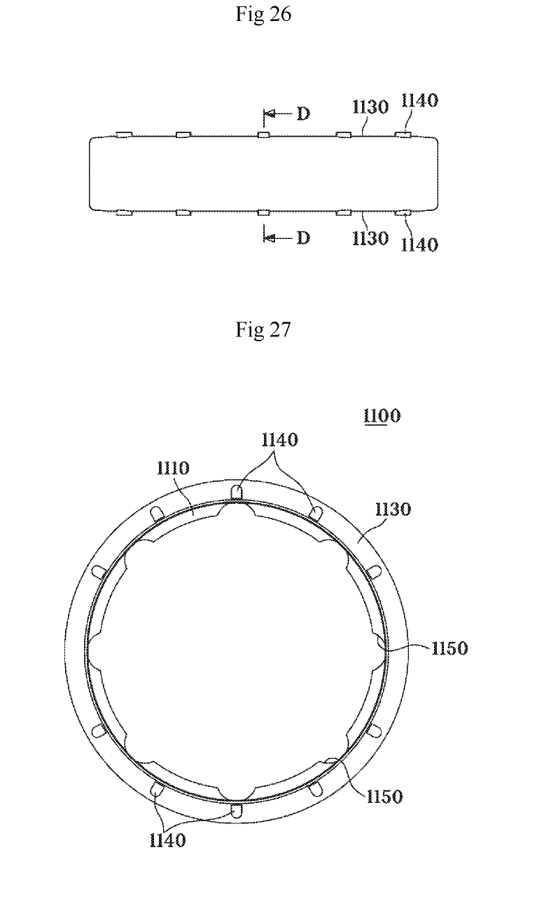

FIG. 26 is a front view of FIG. 25;

FIG. 27 is a plan view of FIG. 25; and

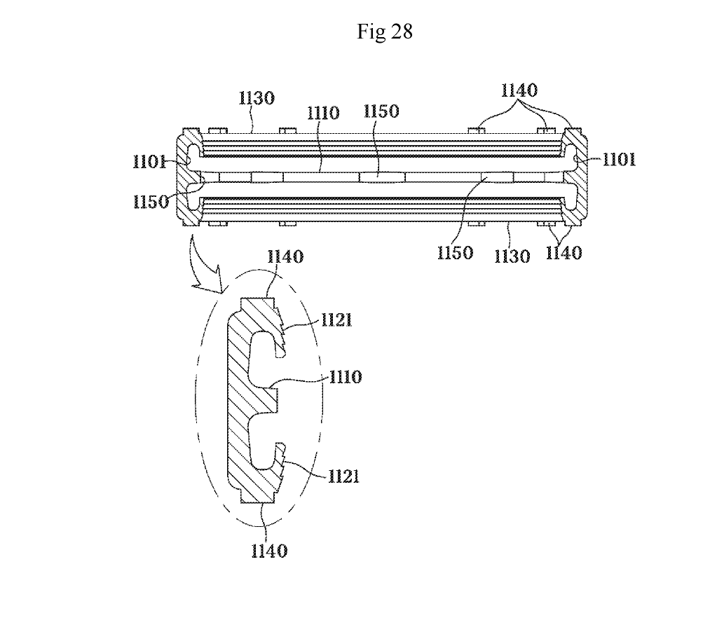

FIG. 28 is a cross-sectional view taken along line D-D of FIG. 26.

### DETAILED DESCRIPTION

Hereinafter, a seismic grooveless coupling according to embodiments of the present invention will be described in detail with reference to the accompanying drawings.

When reference numerals are assigned to components of each drawing, although the same components are illustrated in different drawings, the same numerals are assigned to the same components whenever possible. In embodiments of the present invention, when detailed descriptions of a related well-known technology are deemed to unnecessarily obscure the gist of embodiments of the present invention, they will be omitted. Also, directional terms, such as “top,” “bottom,” “front,” “rear,” “front end,” “rear end,” etc. are used with respect to orientations of the disclosed drawing(s). Because the components of the embodiment of the present invention may be positioned in various orientations, the directional terms are used for an example, but it is not limited thereto.

A seismic grooveless coupling 1000 according to a first embodiment of the present invention, as shown in FIGS. 1 to 9, includes a packing 1100 formed of an elastic material into which pipes 1 and 2 that transfer fluid are separately inserted from left and right sides, upper and lower coupling segments 1200 and 1300 configured to surround the packing 1100 to be accommodated therein from upper and lower sides and restrict axial movements of the pipes 1 and 2 at both ends when getting closer to each other, and a bolt 1410 and a nut 1420 fastening the upper and lower coupling segments 1200 and 1300 each other.

In this case, the upper and lower coupling segments 1200 and 1300 include gripping parts 1220 and 1320 having a sawtooth-shape and formed at inner circumferential surface-center direction-both ends 1210 and 1310, and the gripping parts 1220 and 1320 are smaller than radiuses of the pipes 1 and 2 and have a hardness higher than those of the pipes 1 and 2.

Therefore, when the pipes 1 and 2 are pushed to both sides of the packing 1100, and the bolt 1410 and the nut 1420 of a fastening unit 1400 are fastened to each other, the gripping parts 1220 and 1320 that have a smaller radius than the pipes are stuck in outer circumferential surfaces of the pipes 1 and 2 while the upper and lower coupling segments 1200 and 1300 get closer to each other, and thus the pipes 1 and 2 can simply prevented from being detached in an axial direction.

The upper and lower coupling segments 1200 and 1300, which are main parts of embodiments of the present invention, include incised grooves 1230 and 1330 formed with a predetermined width in an axial direction at regular angles in a radial direction of the inner circumferential surface-center direction-both ends 1210 and 1310, and having a slot shape to be formed from an outer diameter of the gripping part to an inner diameter of the packing accommodating groove.

Therefore, when the bolt 1410 and the nut 1420 of the fastening unit 1400 are fastened with each other, the packing 1100 is surrounded and pressed while radiuses of the upper and lower coupling segments 1200 and 1300 get easily smaller by the incised grooves 1230 and 1330. The gripping parts 1220 and 1320 are stuck in the pipes 1 and 2 while contracting with the upper and lower coupling segments 1200 and 1300.

Also, a spacing elastic member 1500, which is a rubber tube with a predetermined length, is further provided between both end-flanges 1240 and 1340 which are perpendicular to an axial direction of the upper and lower coupling segments 1200 and 1300 fastened by the fastening unit 1400, and the bolt 1410 is inserted into an axial center of the spacing elastic member 1500.

Therefore, when the spacing elastic member 1500 is disposed between the flanges 1240 and 1340, and the fastening unit 1400 is briefly fastened with less power as a first stage, the pipes 1 and 2 are assembled as a first stage while maintaining a predetermined distance so that the pipes 1 and 2 are inserted into both sides of the packing 1100 without an interference from the gripping parts 1220 and 1320 of the upper and lower coupling segments 1200 and 1300. When the pipes 1 and 2 are inserted toward the gripping parts 1220 and 1320 of the upper and lower coupling segments 1200 and 1300 and then the fastening unit 1400 is fastened with power greater than the first stage, the gripping parts 1220 and 1320 are assembled to be stuck in the outer circumferential surfaces of the pipes 1 and 2 while pressing the spacing elastic member 1500.

Meanwhile, the packing 1100 includes a circular pipe stopper 1110 formed to protrude from an axial center of a packing-first inner surface 1101 toward an axial center to prevent the pipes 1 and 2 inserted from both left and right sides of an axial direction to transfer fluid from being attached to each other, and a pipe sealing part 1120 having both sides surfaces into which outer circumferential surfaces 1a and 2a of ends of the pipes 1 and 2 are inserted, wherein each of the side surfaces has a C-shaped cross-section, and the pipe sealing parts 1120 on both ends of the packing 1100 include a plurality of sawtooth-shaped sealing lips 1121 attached to the outer circumferential surfaces 1a and 2a of ends of the pipes 1 and 2.

Therefore, when fluid is transferred when the lengths of pipes 1 and 2 are reduced due to a low temperature of external air, remaining sealing lips 1121 stuck in the outer circumferential surfaces 1a and 2a are pressurized toward the outer circumferential surfaces of the pipes by a pressure of the fluid, and thus a sealing between the pipes 1 and 2 and the packing 1100 is performed.

Also, incised groove-mounting protrusions 1140, which are reinforcing members to prevent the packing 1100 from bursting toward the incised grooves 1230 and 1330 by a pressure generated when the packing 1100 is inserted into the incised grooves 1230 and 1330, are formed on both sides 1130 of the packing 1100.

Therefore, when the fluid is supplied to the pipes 1 and 2, the incised groove-mounting protrusion 1140 formed on the packing 1100 of the seismic grooveless coupling 1000 allows the both sides 1130 of the packing 1100 not to easily burst.

A seismic grooveless coupling 1000 according to a second embodiment of the present invention is shown in FIGS. 10 to 13, the same elements as the first embodiment of the present invention will be denoted with the same reference numerals, and detailed descriptions thereof will be omitted.

Hereinafter, a heat-treated gripping part for fixing, which is a main part of the second embodiment, will be described. The gripping part includes circle-shaped first grooves 1250 and 1350 which are inner circumferential surface-both ends 1210 and 1310 formed when the upper and lower coupling segments 1200 and 1300 are assembled and are formed in an axial center of the incised grooves 1230 and 1330, and a C-shaped gripping fixing ring 1600 inserted and mounted into the first grooves 1250 and 1350 and having a cut side. The gripping fixing ring 1600, which is a heat-treated stainless steel (SUS) series, has a sawtooth-shaped gripping surface 1610 formed on an inner circumferential surface thereof.

Therefore, gripping parts 1220 and 1320 according to a second embodiment are not configured to be integrated with the upper and lower coupling segments 1200 and 1300 as shown in the first embodiment and include the first grooves 1250 and 1350 and the C-shaped gripping fixing ring 1600 with the gripping surface 1610 pressing outer circumferential surfaces of the pipes 1 and 2, and thus the gripping parts are easily processed, and less time and efforts for maintenance are required.

Meanwhile, a general movable seismic grooveless coupling 1000 according to a third embodiment of the present invention is shown in FIGS. 14 to 19, the same elements as the first and second embodiments of the present invention will be denoted with the same reference numerals, and detailed descriptions thereof will be omitted.

Hereinafter, a gripping part which is a main part of the third embodiment 3 will be described. The gripping part includes circle-shaped second grooves 1260 and 1360 which are inner circumferential surface-both ends 1210 and 1310 formed when the upper and lower coupling segments 1200 and 1300 are assembled and are formed in the axial center of the incised grooves 1230 and 1330, a C-shaped movable ring 1700 having one cut side to be inserted into the second grooves 1260 and 1360, having an outer circumferential surface formed to be parallel to an axial direction to move in an axial direction of the second grooves, and having a third groove 1710 formed on an inner circumferential surface thereof, and a gripping fixing ring 1800 having a sawtooth-shape to press the outer circumferential surfaces of the pipes 1 and 2 with an inner circumferential surface and having one cut side with a C-shaped cross-section to be inserted into the third groove.

Therefore, when the pipes 1 and 2 expand, the gripping fixing rings 1800 on the left and right sides fix the circumferential surfaces 1a and 2a of ends of the pipes 1 and 2 and move with the C-shaped movable ring 1700 toward the packing 1100 along the second grooves 1260 and 1360 of FIG. 16. When the pipes 1 and 2 contract due to cold weather, the gripping fixing rings 1800 grip the circumferential surfaces 1a and 2a of ends of the pipes 1 and 2 and move with the C-shaped movable ring 1700 toward the direction opposite the packing 1100 along the second grooves 1260 and 1360 of FIG. 16, and thus the movable seismic grooveless coupling which may properly correspond to the contracting pipes 1 and 2 can be provided.

The third groove 1710 of the movable ring 1700 has an inner circumferential surface having a curved surface, and an outer circumferential surface of the gripping fixing ring 1800 is also a curved surface corresponding to the inner circumferential surface of the third groove 1710.

Therefore, when the pipes 1 and 2 have a small movement or vibration in a vertical direction rather than a longitudinal direction, a spherical surface formed on the outer circumferential surface of the gripping fixing ring 1800 slides on a spherical surface formed on the third groove 1710 of the movable ring 1700 while the gripping fixing rings 1800 fix the circumferential surfaces 1a and 2a of ends of the pipes 1 and 2, and thus an impact can be reduced while moving in the vertical direction rather than the longitudinal direction of the pipes 1 and 2.

Meanwhile, a general high pressure movable seismic grooveless coupling 1000 according to a fourth embodiment of the present invention is shown in FIG. 20, the same elements as the third embodiment of the present invention will be denoted with the same reference numerals, and detailed descriptions thereof will be omitted.

Hereinafter, the high pressure movable seismic grooveless coupling 1000 of the fourth embodiment further includes a circle-shaped press maintaining plate 1900 which is a backup ring and is formed between the inner circumferential-center direction-both ends 1210 and 1310 with the gripping parts 1220 and 1320 and both sides 1130 of the packing 1100, that is, between packing mounting grooves 1201 and 1301 in which the packing 1100 of the upper and lower coupling segments 1200 and 1300 is mounted.

When the circle-shaped press maintaining plate 1900 is inserted into the packing mounting grooves 1201 and 1301 and attached to both sides 1130 of the packing 1100, the packing 1100 does not need a incised groove-mounting protrusion 1140.

Therefore, when a high pressure fluid is supplied to the pipes 1 and 2, the circle-shaped press maintaining plate 1900 blocks the incised grooves 1230 and 1330 formed on the inner circumferential surface-center direction-both ends 1210 and 1310 of the upper and lower coupling segments 1200 and 1300 to prevent both side surfaces of the packing 1100 from bursting toward the incised grooves 1230 and 1330, and thus the packing 1100 can be used without damage even though a high pressure fluid is supplied.

A seismic grooveless coupling 1000 of a fifth embodiment, which is another embodiment, is shown in FIGS. 21 to 28, the same elements as the first to fourth embodiments of the present invention will be denoted with the same reference numerals, and detailed description thereof will be omitted.

Hereinafter, heat-treated gripping parts 1220 and 1320 for fixing, which are main parts of the fifth embodiment, will be described. The gripping parts 1220 and 1320 include a fourth groove 1370 which is inner circumferential surface-both ends 1210 an 1310 formed by assembling the upper and lower coupling segments 1200 and 1300 and has a fixing ring adhesive surface 1371 formed in the axial center of the incised grooves 1230 and 1330 in a circle shape and having a spherical inner circumferential surface, and a C-shaped gripping fixing ring 1800 inserted into the fourth groove in a width smaller than a width of the fourth groove 1370 and attached from the fixing ring adhesive surface 1371 to come into contact with a spherical surface, and having one cut side. The gripping fixing ring 1800 has a sawtooth-shaped gripping surface 1810 as an inner circumferential surface.

Therefore, in the heat-treated seismic grooveless coupling for fixing, even though the pipes 1 and 2 have a load, such as vibration or shaking in a transverse direction perpendicular to an axial direction of the pipes 1 and 2 rather than the axial direction, while the sawtooth-shaped gripping surface 1810 of the gripping fixing ring 1800 catches the pipes 1 and 2, flow paths of the pipes 1 and 2 can be strongly and firmly maintained while having a contact from the fixing ring adhesive surface 1371 of the fourth groove 1370 to a spherical surface 1820 which is an outer circumferential surface of the gripping fixing ring 1800.

Further, the packing 1100 of the fifth embodiment further includes a plurality of fluid flow guiding grooves 1150 formed on an inner circumferential surface of a pipe-stopper 1110 at the regular angles to communicate with a fluid introduced into the pipe sealing part 1120 into which outer circumferential surfaces 1a and 2a of ends of the pipes 1 and 2 are inserted.

Therefore, when a pressure is generated due to supply of a fluid to the pipes 1 and 2, the fluid flow guiding groove 1150 allow a fluid introduced into between the packing-first inner surface 1101 and the pipe sealing part 1120 through a contact surface between the pipe stopper 1110 and the pipes 1 and 2 to flow to the pipes 1 and 2 again to prevent contamination, and thus clean water can be supplied to people.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A seismic grooveless coupling comprising:
a packing made of an elastic material, wherein pipes transferring fluid are inserted into the packing from left and right sides in a central direction of the packing;
upper and lower coupling segments including packing accommodating grooves formed to surround and accommodate the packing from upper and lower sides, an outer diameter of a gripping part having a diameter less than that of a packing accommodating-outer circumferential surface with the packing accommodating groove and extending from both sides of the packing accommodating-outer circumferential surface, and gripping parts formed at both ends of an inner circumferential surface with the packing accommodating groove in a sawtooth shape to restrict the axial movements of the pipes while getting closer to each other; and
a fastening unit configured to fasten the upper and lower segments each other,
wherein the upper and lower coupling segments include incised grooves which are an inner circumferential surface in which the packing accommodating groove is formed, are formed with a predetermined width in an axial direction at regular angles in a radial direction of center direction-both ends, and have a slot shape to be formed from the outer diameter of the gripping part to the inner diameter of the packing accommodating groove.

2. The coupling of claim 1, wherein the gripping parts include:
a first groove which is an inner circumferential surface-both end configured by assembling the upper and lower coupling segments, is formed in an axial center part of the incised groove in a circle shape, and has a fixing ring adhesive surface having a spherical inner circumferential surface; and
a gripping fixing ring inserted into the first groove in a width less than a width of the first groove to come into contact with the spherical surface from the fixing ring adhesive surface and having a C shape made by cutting one side thereof,
wherein the gripping fixing ring has an inner circumferential surface in a sawtooth shape.

3. The coupling of claim 1, wherein the packing includes:
a pipe stopper formed at an axial center of a packing-first inner surface to protrude toward an axial center to prevent the pipes from being attached to each other and formed in a circular shape; and
pipe sealing parts formed at both ends extending from the packing-first inner surface in an axial direction and having a C-shaped cross-section to be attached to the outer circumferential surfaces of ends of the pipes inserted into the both ends,
wherein an inner circumferential surface of the pipe stopper has a plurality of fluid flow guiding grooves formed at regular angles and communicating with a space between the pipe sealing part and the packing-first inner surface so that a fluid introduced into the space flows to the pipes.

4. The coupling of claim 3, wherein the packing includes incised groove-mounting protrusions which are reinforcing members to prevent the packing from bursting toward the incised grooves by a pressure while being inserted into the incised grooves and formed at both surfaces thereof.

5. The coupling of claim 3, wherein:
the fastening unit includes a bolt and a nut and further includes a spacing elastic member which is a rubber tube with a predetermined length and formed between both ends perpendicular to an axial direction of the upper and lower coupling segments fastened by the fastening member; and
the bolt is inserted into an axial center of the spacing elastic member.

6. The coupling of claim 3, wherein the pipe sealing parts on both ends of the packing include a plurality of sawtooth-shaped sealing lips attached to the outer circumferential surfaces of the ends of the pipes.

7. The coupling of claim 1, wherein the gripping parts include:
second grooves which are both ends of the inner circumferential surface formed by assembling the upper and lower coupling segments and are formed in a circular shape at an axial center of the incised grooves;
C-shaped movable rings having one cut side to be inserted into the second grooves, having an outer circumferential surface formed to be parallel to an axial direction to move in an axial direction of the second groove, and having a third groove formed on the inner circumferential surface thereof; and
a gripping fixing ring having a sawtooth shape at an inner circumferential surface thereof and having one cut side with a C-shaped cross-section to be inserted into the third groove,
wherein an inner circumferential surface of the third groove of the movable ring is a curved surface, and
an outer circumferential surface of the gripping fixing ring is also a curved surface corresponding to the inner circumferential surface of the third groove.

8. The coupling of claim 7, further including a circle-shaped press maintaining plate disposed in a packing mounting groove in which the packing of the upper and lower coupling segments is mounted, wherein the press maintaining plate is installed between both surfaces of the packing and the gripping parts.

9. The coupling of claim 7, wherein the packing includes:
a pipe stopper formed at an axial center of a packing-first inner surface to protrude toward an axial center to prevent the pipes from being attached to each other and formed in a circular shape; and
pipe sealing parts provided at both ends axially extending from the packing-first inner surface and having a C-shaped cross-section to be attached to the outer circumferential surfaces of ends of the pipes inserted into the both ends,
wherein the pipe stopper includes a plurality of fluid flow guiding grooves formed at regular angles to communicate with the packing-first inner surface so that fluid on the packing-first inner surface flows.

10. The coupling of claim 9, wherein the packing includes incised groove-mounting protrusions which are reinforcing members to prevent the packing from bursting toward the incised grooves due to a pressure generated when the both ends of the packing are inserted into the incised grooves and are formed on both sides thereof.

11. The coupling of claim 9, wherein:
the fastening unit includes a bolt and a nut and further includes a spacing elastic member which is a rubber tube with a predetermined length and formed between both ends perpendicular to an axial direction of the upper and lower coupling segments fastened by the fastening unit; and
the bolt is inserted into an axial center of the spacing elastic member.

12. The coupling of claim 9, wherein the pipe sealing parts on both ends of the packing include a plurality of sawtooth-shaped sealing lips attached to outer circumferential surfaces of ends of the pipes.

13. A seismic grooveless coupling comprises:
a packing made of an elastic material, having pipes transferring a fluid and inserted thereto from left and right sides in a central axis direction, and including a pipe stopper formed at an axial center of a packing-first inner surface to protrude toward an axial center to prevent the pipes from being attached to each other and formed in a circular shape, and pipe sealing parts provided at both ends axially extending from the packing-first inner surface and having a C-shaped cross-section to be attached to outer circumferential surfaces of ends of the pipes inserted into the both ends;
upper and lower coupling segments including a packing accommodating groove formed to surround and accommodate the packing from upper and lower sides, outer diameters of gripping parts having a diameter smaller than a diameter of a packing accommodating outer circumferential surface in which the packing accommodating groove is formed and extending from both sides of the packing accommodating outer circumferential surface, and gripping parts formed at both ends of an inner circumferential surface in which the packing accommodating groove is formed and having a sawtooth shape to restrict axial movements of the pipes while getting closer to each other; and
a fastening unit configured to fasten the upper and lower coupling segments each other,
wherein the pipe stopper includes a plurality of fluid flow guiding grooves formed at regular angles to communicate with a space between the packing-first inner surface and the pipe sealing part so that a fluid flowing to the pipe is introduced between the packing-first inner surface and the pipe sealing part and then flows through the pipes again.

14. The coupling of claim 13, wherein the upper and lower coupling segments include:
incised grooves which are an inner circumferential surface in which the packing accommodating groove is formed, are formed with a predetermined width in an axial direction at regular angles in a radial direction of center direction-both ends, and have a slot shape to be formed from the outer diameter of the gripping part to the inner diameter of the packing accommodating groove; and
incised groove-mounting protrusions which are reinforcing members to prevent the packing from bursting toward the incised grooves by a pressure while being inserted into the incised grooves and are formed at both surfaces the packing.

15. The coupling of claim 14, wherein the pipe sealing part of the packing includes a plurality of sawtooth sealing lips attached to outer circumferential surfaces of ends of the pipes.
